(19) United States
(12) Patent Application Publication
(10) Pub. No.: US 2011/0247461 A1
(43) Pub. Date: Oct. 13, 2011

(54) LID REMOVAL TOOL

(75) Inventor: Joseph T. Cero, JR., Telford, PA (US)

(73) Assignee: CMW, Telford, PA (US)

(21) Appl. No.: 12/757,467

(22) Filed: Apr. 9, 2010

(51) Int. Cl. B67B 7/14

(52) U.S. Cl. 81/3.4

(57) ABSTRACT

A combination of a lid knob and tool having interlocking capability provides an easily removed tool with a handle for applying an added prying, lifting or twisting force to a lid. The vertical cross-section of a sliding interlocking engagement is a dovetail shape. The knob is elongate and the slidable engagement between the tool assembly and the elongate knob positioned horizontally across the top of the lid allows for the selective positioning of the tool at different points on the knob.

### FIELD OF THE INVENTION

The present invention relates to tools used for grasping and lifting lids of containers. More specifically, it relates to a tool which may be removably engaged with the lid in order to provide and enhance lifting force not manually achievable without use of the tool.

### BACKGROUND OF THE INVENTION

Various containers or vessels include lids which rest on or are otherwise engaged with a rim surface around the top sides of the container. Such containers are found throughout households and commercial industry and are ubiquitous in daily use. Because of the nature of the container environment or the substances in the containers, the lids often become adhered to or otherwise stuck to the rim of the container. A wedge-shaped tool such as a screwdriver is often used to pry lids open. However, because of the nature of some of these containers including the tightness of the seam around the edge of the lid rim, the use of a tool such as a screw driver sometimes is not desirable or possible. In many cases it is to be avoided to prevent damage to either the container or the lid.

To facilitate lid removal, lids include a knob or some type of fixed handle for manually grasping and lifting the lid. For space and esthetic reasons, the lifting knobs are usually small and centered on the lid. While small knob dimensions are sufficient for most situations, in some instances the lid becomes stuck requiring greater lifting force. This need for greater lifting force presents a problem when the aforementioned prying-type tool cannot be used at the edge of the container. There is therefore a need in the art for a non-edge lifting tool for knobbed lids which can assist in lifting the lid and opening the container when the lid has become stuck.

To meet the needs in the art, it is therefore the main objective of the present invention to provide a specialized lifting tool which operates only on the top of the lid to apply an added prying force to assist opening the lid. Other objects and advantages of the invention will become apparent to those of ordinary skill in the art from the following description.

### SUMMARY OF THE INVENTION

In order to solve the problems in the art, the present lid removal tool has been devised. As described herein, the combination of a knob and tool with interlocking compatibility provides an easily removed tool for applying an added prying, lifting or twisting force to the lid. The tool includes a handle which provides a lever arm to increase the pry force against the lid. One embodiment of the device is particularly applicable to situations where the combined weight of a lid's container and its contents are sufficient to resist the forces applied to the lid, or where the body of the container can be held or in some way stabilized.

More specifically, the Applicant has devised the combination of a lid and removal tool in which the lid includes a knob that projects upwardly from a top surface of the lid. At the juncture of the knob with the lid, the cross-section of the knob is narrower than a top portion of the knob. In the preferred embodiment, the vertical cross-section of the knob is a dovetail shape. To apply a sideways or lateral prying force to the lid, a removable tool is provided which slidably engages and disengages with the knob. This is achieved by a close mating engagement between a slot in a shoe at the end of the tool and the knob. The structural integrity of the tool/knob connection is owing to the vertical cross-section of the slot closely matching the knob cross-section. The tool includes an elongate handle providing a lever arm which extends from the shoe. In one embodiment, the shoe includes a ball and spring assembly whereby the ball exerts a force against the top of the knob to increase the sliding friction between the knob and the shoe to avoid accidental disengagement of the tool. To further enhance the structural interconnection of the handle and the knob, the base of the shoe includes a planar bottom surface which slidably abuts the top surface of the lid as the shoe is moved over the knob. The shoe has two feet providing a pair of bottom surfaces which contact the lid top surface on the opposite sides of the knob. The lid can be the lid of a container such as a sanitary container.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a top left front isometric view of the tool with the container lid shown in phantom.

FIG. 2 is a left side partially sectioned elevation view taken from FIG. 1 as shown in that Figure with the container lid shown in phantom.

FIG. 3 is a front elevation sectional view taken from FIG. 2 as shown in that Figure with the container lid shown in phantom.

FIG. 4 is a top left isometric assembly view.

### DESCRIPTION OF THE PREFERRED EMBODIMENT

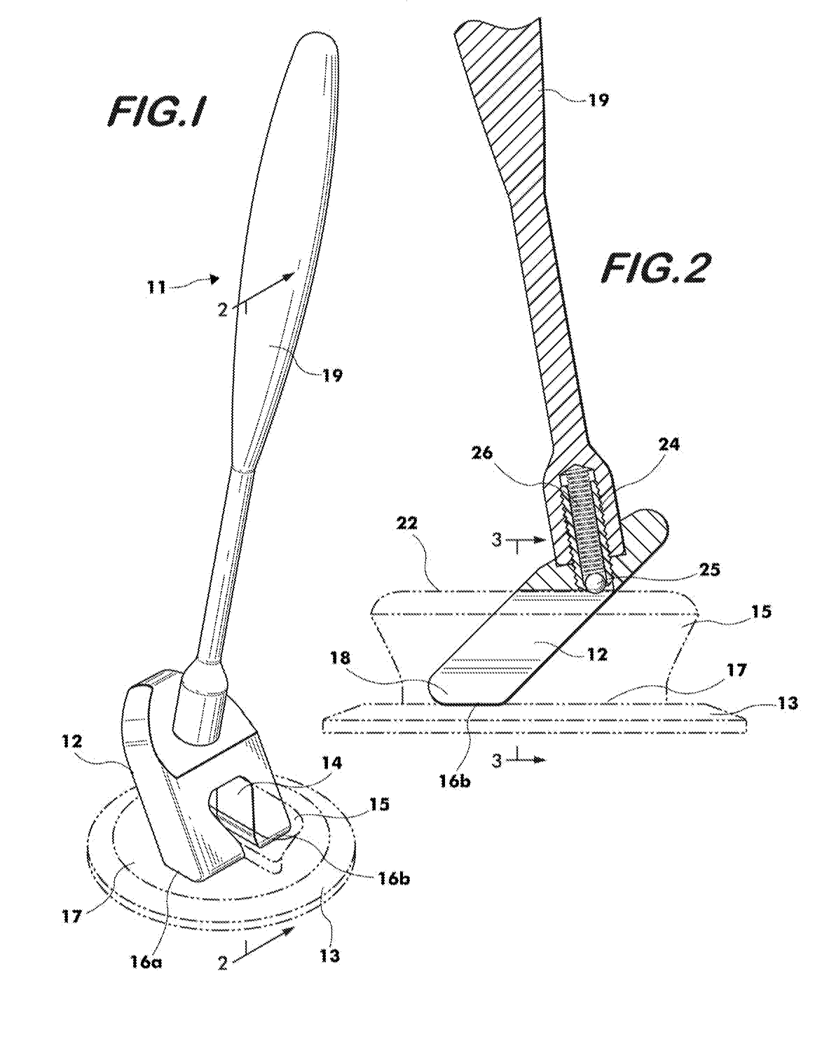

Referring to FIG. 1, the prying tool 11 is used to lift the lid 13 from a small sanitary container (not shown). The tool is depicted engaged with a knob 15 and resting on the top surface 17 of the lid 13. In this Figure, the lid 13 is being shown in phantom. The tool includes an elongate handle 19 which provides a lever arm for manually applying a prying and/or twisting force to the lid 13. At the end of the handle, a shoe 12 includes a slot 14 that matingly engages the outer surface of the knob 15. The shoe further includes two planar bottom surfaces 16a and 16b that slidingly contact the parallel planar top surface 17 of the lid 13 as the tool is being engaged and disengaged with the knob. This is shown more clearly in FIG. 2.

Referring now to FIG. 2, a toe portion 18 of the shoe 12 includes the aforementioned planar bottom surface 16b which slidingly abuts the planar top surface 17 of the lid. In order to prevent accidental or inadvertent disengagement between the tool and the lid, a friction ball and spring assembly applies a contact force against the top surface 22 of the knob. Substantially the entire top surface of the knob is planar and also parallel to the top surface 17 of the lid. A friction assembly which will be further described in FIG. 4 includes an externally threaded cylinder 24 that affixes the handle 19 to the shoe 12 by mutual threaded engagement with each member. The bottom end of the cylinder includes an aperture of reduced diameter to contain the ball 25 within the cylinder 24. A spring 26 applies a biasing force between an end wall of a blind hole in the end of the handle and the ball 25. By this assembly of parts it will be readily understood that the ball is resiliently biased against the top of the knob.

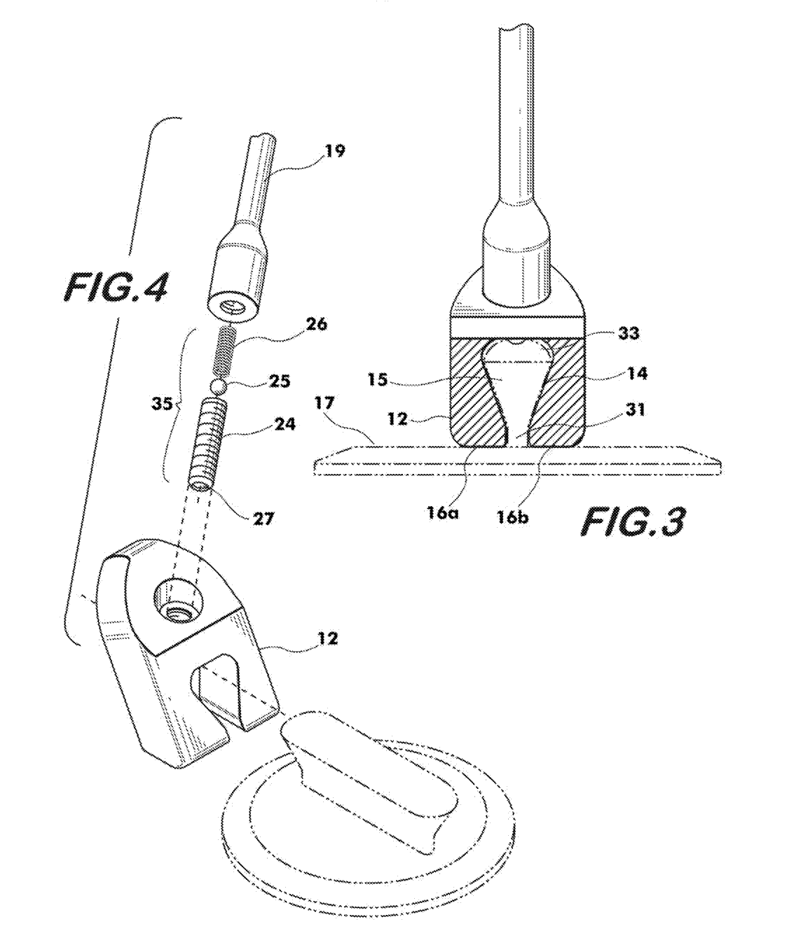

Referring now to FIG. 3, the mating engagement between the slot 14 in the shoe 12 and the outer surface of the knob 15 is shown. As depicted in this Figure the cross-section of the knob, and correspondingly that of the slot, is substantially a dovetail shape with a bottommost opening of the slot being narrower than the top portion. Likewise, the top portion 33 of the knob is much wider than the bottom 31 of the knob at its juncture with the top surface 17 of the lid. The bottom surfaces of the shoe 16a and 16b abut the planar top surface of the lid. These features contribute to the structural rigidity of the mating engagement between the shoe and lid and allow for the selective horizontal positioning of the shoe at points along the length of the knob.

FIG. 4 shows in greater detail the assembly of the various parts of the embodiment of the invention shown in FIGS. 1-3. As previously described, the mechanical relationship of the parts provides a sliding mating engagement between the tool and the knob by advancing the shoe over one end of the knob. The ball and spring friction assembly 35 evenly supplies a retention force between the shoe and the knob. Externally threaded cylinder 24 threadably interconnects the handle 19 to the shoe 12 and also retains the spring and ball. The end of the cylinder 24 includes an opening of reduced diameter 27 to retain the ball within the cylinder while the spring 26 provides the downward resiliently biased movement of the ball 25.

In use, the tool of the invention allows greater leverage for the application of a lateral or sideways application of a prying force to first lift the edge of the lid opposite the direction of the force applied to the handle. When positioned at the end of the knob, a twisting force as well as a lifting force may be applied to the handle through the shoe. Thus, it will be readily understood by those in the mechanical arts that the present device will be useful in prying open stuck lids or tipping on edge lids that are otherwise to heavy to lift without such a tool. It should be understood that while the preferred embodiment regards a container lid, the present invention is applicable to any type of lid or structure which covers an opening.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. In combination, a lid and lifting tool, comprising:
a lid including a knob projecting upwardly from a top surface thereof, the juncture of said knob with said lid being narrower in vertical cross-section than a top portion of the knob; and
a removable handle assembly in slidable mating engagement and disengagement with said knob for lifting said lid, said handle assembly having a slot with a vertical cross-section shape which closely matches a vertical cross-section of the knob.

2. The apparatus of claim 1 wherein said knob is laterally elongate and disposed diametrically across a circular top surface of the lid.

3. The apparatus of claim 1 wherein said tool comprises a shoe affixed to one end of an elongate handle which houses said slot.

4. The apparatus of claim 3 wherein said slot is a dovetail slot.

5. The apparatus of claim 3 wherein said shoe comprises a resiliently biased member bearing against a top of said knob for increasing friction between said shoe and said knob.

6. The apparatus of claim 5 wherein said member is resiliently biased by a spring.

7. The apparatus of claim 6 wherein said member is a ball.

8. The apparatus of claim 5 wherein a bottom of the shoe abuts the top surface of the lid.

9. The apparatus of claim 1 wherein the entire outer periphery of the knob cross-section closely matches the slot cross-section shape.

10. The apparatus of claim 4 wherein acute corners of said dovetail slot are rounded.

11. The apparatus of claim 8 wherein said shoe has a planar bottom surface which slidingly abuts the top surface of the lid as the tool is applied and withdrawn.

12. The apparatus of claim 11 wherein said shoe includes a pair of bottom surfaces which contact said lid top surface on opposite sides of said knob.

13. The apparatus of claim 12 wherein the entire top surface of the knob is parallel to the top surface of the lid.

14. The apparatus of claim 13 wherein said lid is a container lid.

15. The apparatus of claim 2 wherein said handle assembly is slidably movable to different selected operative horizontal positions along the length of said knob.
